(19) United States
(12) Patent Application Publication
(10) Pub. No.: US 2007/0164995 A1
(43) Pub. Date: Jul. 19, 2007

(54) Ergonomic input device

(75) Inventor: Antonio Pascucci, Seefeld (DE)

Correspondence Address: THE H.T. THAN LAW GROUP, WATERFRONT CENTER SUITE 560, 1010 WISCONSIN AVENUE NW, WASHINGTON, DC, 20007, US

(73) Assignee: 3DCONNEXION GMBH, Seefeld (DE)

(21) Appl. No.: 10/598,964

(22) PCT Filed: Dec. 17, 2004
(86) PCT No.: PCT/EP04/14431

§ 371 Date: Nov. 9, 2006

(30) Foreign Application Priority Data
Mar. 17, 2004 (EP) 04006381.0

(51) Int. Cl. G09G 5/08; G06F 3/033

(52) U.S. Cl. 345/161; 345/163

(57) ABSTRACT

The present invention relates to an ergonomic device (100) for manual input of control signals in a computer environment. The device (100) is adapted for connection in communication with a computer processing unit, and comprises: a base (10) for supporting the device on an operating surface; a control panel (20) provided on the base (10), including a manipulation member (21) mounted on and upstanding from the base (10) for manual manipulation by a user, the manipulation member (21) being movable relative to the base (10) to generate corresponding input control signals within the computer environment; and a palm rest (40) provided on the base (10) for supporting the palm of the user's hand during use of the device (100). The control panel (20) further includes a group of user input buttons (22, 23, 24), each of which can be actuated to generate an associated input control signal, wherein at least one of said buttons (22, 23, 24) is programmable. The device (100) further includes display means (30, 30′) provided on the base (10) for displaying the associated control signal or function programmed for each programmable button.

### FIELD OF THE INVENTION

The present invention relates to an input device that provides an ergonomic manual user interface for a computing or computer-related environment. More particularly, the invention relates to a user interface device with which a user may manually input control signals in a computing or a computer-related environment.

The present invention has particular application as a hand-operated device that serves as a control Signal input interface for a user in the manipulation and processing of digital information, such as digital images, and it will be convenient to describe the invention in this exemplary context. It will be appreciated, however, that the invention is not limited to this application, but may for example also find application in the control of a wide range of robotic and automated machinery.

### BACKGROUND OF THE INVENTION

A broad and ever increasing range of hand-operated devices for user input of control Signals in Computing or digital applications are currently available in the market-place. The more well-known of these devices include the conventional mouse in its various forms, the Joystick and the track-ball.

A relatively recent development of the Applicant, described in US patent publication no. 2003/0103217, relates to a sensor arrangement for the detection of relative movements or the relative position of two objects, and to the incorporation of such a sensor arrangement in a user interface device for inputting control Signals in a Computing environment.

Furthermore, the product range of the Applicant includes a diverse range of user interface accessory devices for Computing applications, including the SpaceBall™, the SpaceMouse™ and the CadMan™.

Naturally, the efforts to optimize ergonomics and the ease of handling and processing of data and information in the Computing environment are on-going, particularly in relation to a range of specific Software applications. The present invention represents a continuation of that optimization process, with the control of CAD and image processing Software applications in mind. In particular, the present invention is based on the object of creating an improved user interface accessory device from the point of view of functionality and ergonomics, most preferably suited to CAD/CAM and image processing applications.

### SUMMARY OF THE INVENTION

According to a first aspect of the present invention, an ergonomic device for manual input of control signals in a computer-controlled environment comprises a base geometrically arranged to rest on a support surface. A manipulation member is mounted on the base for manual manipulation by a user. The manipulation member can be movable relative to the base for generating corresponding input control signals within the computer environment. A display is provided on the base. A palm rest can be provided on the base for supporting the palm of the user's hand during use of the device. The manipulation member can be arranged between the display and the palm rest.

According to a further aspect the display can be inclined in an acute angle to the support surface.

According to a still further aspect, the upper surface of the base can be raised in the region of the display in comparison to the region of base of the manipulation member.

### BRIEF DESCRIPTION OF THE DRAWINGS

Particular embodiments of the user interface device according to the present invention are hereafter described by way of example with reference to the accompanying drawings, in which like reference characters designate like parts throughout the several views, and in which:

FIG. 1 is a schematic plan view of a user interface device according to one preferred embodiment of the invention;

FIG. 2 is a perspective view of a user interface device essentially corresponding to the preferred embodiment of FIG. 1;

FIG. 3 is a schematic layout of a control panel for a user interface device according to another preferred embodiment of the invention, and

FIG. 4 is a side view of an ergonomic input device according to the present invention.

### DETAILED DESCRIPTION OF THE PREFERRED EMBODIMENTS

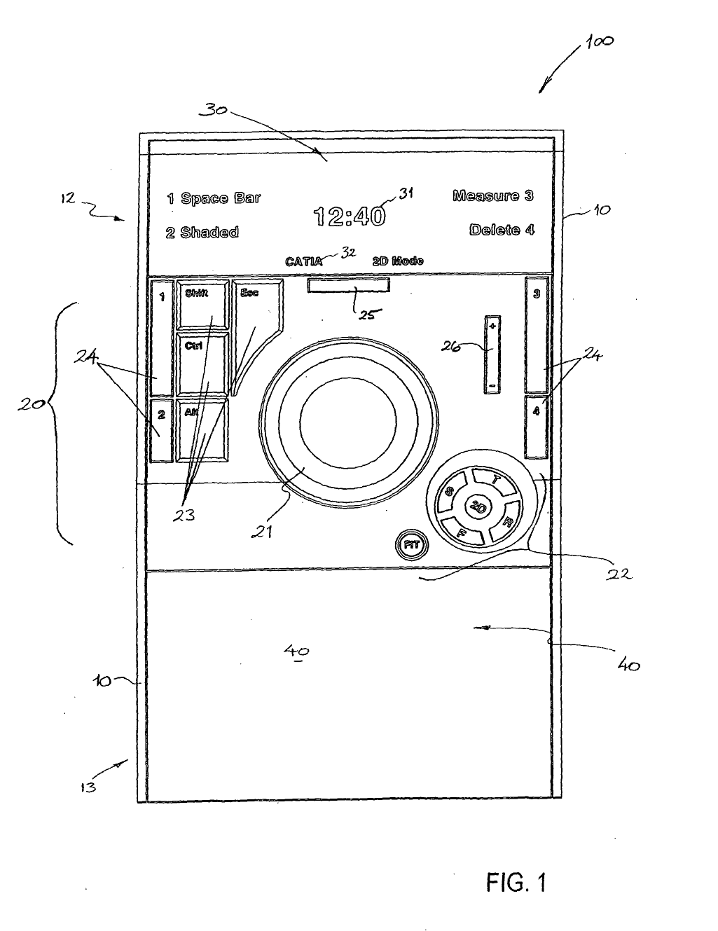

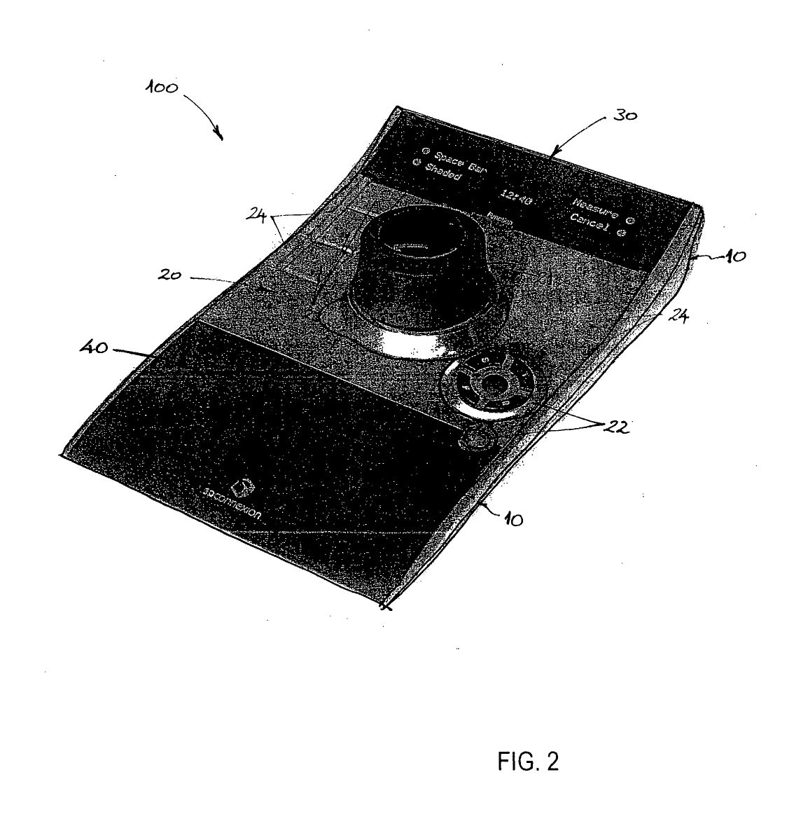

Referring firstly to FIGS. 1 and 2 of the drawings, a top schematic view and a perspective view of a user interface device 100 according to the invention are shown. The user interface device 100 of the invention is adapted for the manual input of control signals in a computer environment, and especially for input of 2D and 3D screen-object or real-object motion control signals e.g. in CAD, animation design or robotic applications. The device 100 in this embodiment has a generally rectangular configuration comprising a relatively flat base member 10, the upper side 11 of which is visible in FIG. 1. The underside (not shown) is adapted to rest at least partially on a supporting surface, such as the top of the table or desk, and optionally includes footings (not shown), e.g. of rubber, to grip the supporting surface.

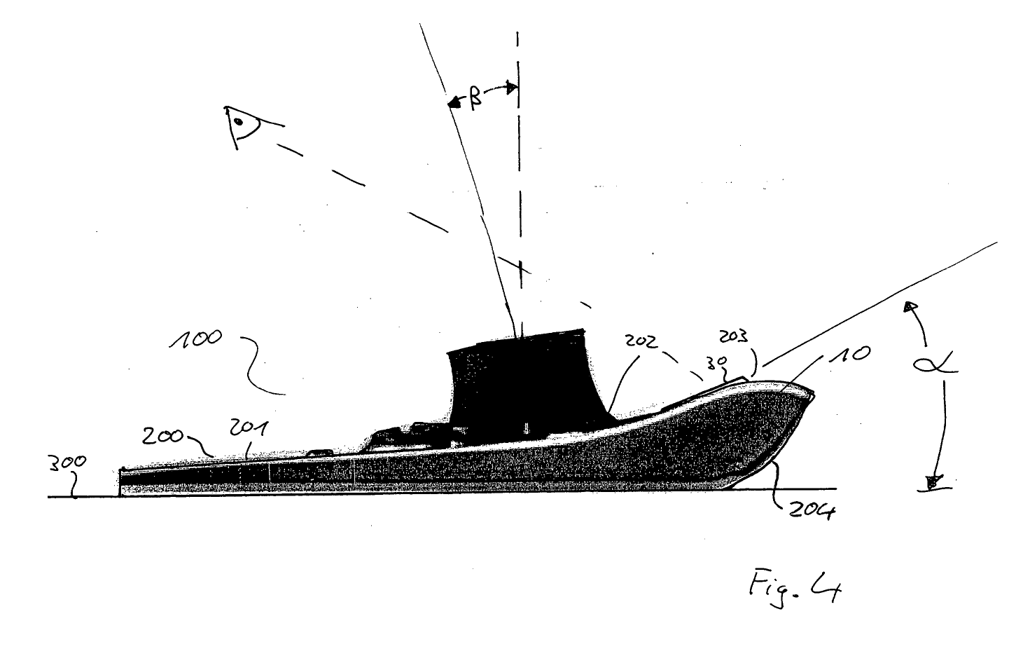

As can be seen in FIG. 4, particularly the underside of the region of the display is not necessarily in contact with the support surface, but can be elevated to further improve the overall ergonomics of the input device according to the present invention.

Provided on the upper side 11 of the base member 10, the user interface device 100 of the invention includes a control panel 20 having a first manipulation member 21 e.g. in the form of a knob-like element. The control panel 20 furthermore includes three groups 22, 23, 24 of push-button type user input switches, buttons or relays arranged in the vicinity of the knob-like element 21.

“In the vicinity” is to be understood such that the control panel elements 22, 23, 24 are arranged relative to the manipulation member 20 such that fingers of the user's hand can manipulate the control panel elements 22, 23, 24 while the user's hand can remain in contact with the manipulation member 20.

The device 100 can also include a display panel 30 arranged e.g. at one end region 12 of the base member 10, and a palm rest 40 located at the opposite end region 13. Accordingly, in the embodiment shown in FIG. 1, the control panel 20 of the user interface device is located essentially between the palm rest 40 and the display panel 30. Note that other positions for the control panel 20 can be devised.

The palm rest 40 can be exchangeable in order to adapt the input device 100 to the users' hand and preferences.

The manipulation member 21 is preferably adapted for translational and rotary relative movements vis-a-vis the base member 10 against a feedback force (“force-feedback control”). Any rotary and/or translational movement of the manipulation member 21 is effected against a resilient feedback force e.g. provided by spring or rubber-elastic elements (not shown) to return to the home (“zero”) position. In each case, the movements of the manipulation member 21 relative to the base 10 are adapted to generate corresponding control signals. The manipulation member 21 is adapted for “fingertip control”, such that rotary and/or translational movement of the knob-like element can be readily achieved with finger strength, against a spring bias.

The particular embodiment illustrated is designed for left-handed use, such that when the palm of the users hand rests upon the palm rest 40, the knob-like manipulation member 21 is generally aligned with, and within reach of, the three middle fingers of the user's hand.

The first group 22 of user input buttons comprises six buttons, five of which are provided in a circular arrangement in the vicinity of where the user's thumb would reach—to the lower right-hand side of the knob-like element 21 as seen in the drawing. This first group of six buttons 22 are referred to as the “views” buttons. The four buttons in forming the circle are labeled F, T, R and S, which correspond to the standard “Front”, “Top”, “Right” and “Sketch Plain” views. The buttons of the first group 22 are located at the end of a frusto-conical stub or protrusion which faces or is directed towards the tip of the user's thumb to further facilitate user access and ergonomics. The sixth button of this group 22 is labeled “FIT” and belongs functionally with the “views” buttons. It's designed to perform a “re-fit” function, i.e. to fit a selected image portion to the user's monitor screen.

The second group 23 of user input buttons (labeled SHIFT, CTRL, ALT and ESC) are provided in the vicinity of where the user's littlest finger would reach—to the upper left-hand side of the knob element 21 as seen in the drawing. This second group of buttons 23 is referred to as the “high frequency” or the “keyboard” buttons. These buttons can be labeled with the same name, and perform the same function as, the corresponding keyboard keys. Furthermore, because these buttons 23 are typically used on a frequent basis, they are preferably relatively large to enable easy access and operation by the user. Accordingly, the availability of these “keyboard” buttons on the user interface device (100) greatly assists in reducing the otherwise frequent hand movements to and from the regular keyboard, thereby economizing on time and simplifying the process.

Finally, the control panel 20 in the embodiment of FIGS. 1 and 2 includes a third group 24 of user input buttons labeled 1, 2, 3 and 4. Two of these buttons are arranged at the extreme left-hand side of the control panel 20 and two of them are at the extreme right-hand side of the control panel. This third group of buttons 24 are the application buttons. Each of these four buttons 24 is programmable, which enables the user to configure the user interface device 100 of the invention to the particular software application for which it is being used. Accordingly, the user inter-face device 100 typically includes operating software which enables the control signal associated with the actuation of each of the buttons in this group 24 to be set by the user, preferably after selection from a number of possible alternatives.

Importantly, the display panel 30 across the top end region 12 of the user inter-face device is in the form of a single large LCD display screen. It can optionally be adapted to show the user the particular function that has been programmed for each of the but-tons labeled 1-4. This can be seen in FIG. 1, which illustrates the display panel 30 showing the number of the button and a brief description or keyword denoting the corresponding function programmed for that button. In addition, the display panel 30 also displays the time of day 31, the name of the particular software application 32 for which the device 100 is currently employed, as well as other status information. The display panel 30 is preferably arranged on the base 10 inclined at an angle, e.g. about 45°, relative to the horizontal surface of the table or desktop upon which the device is supported in order to enhance the user's ability to read the display at a glance.

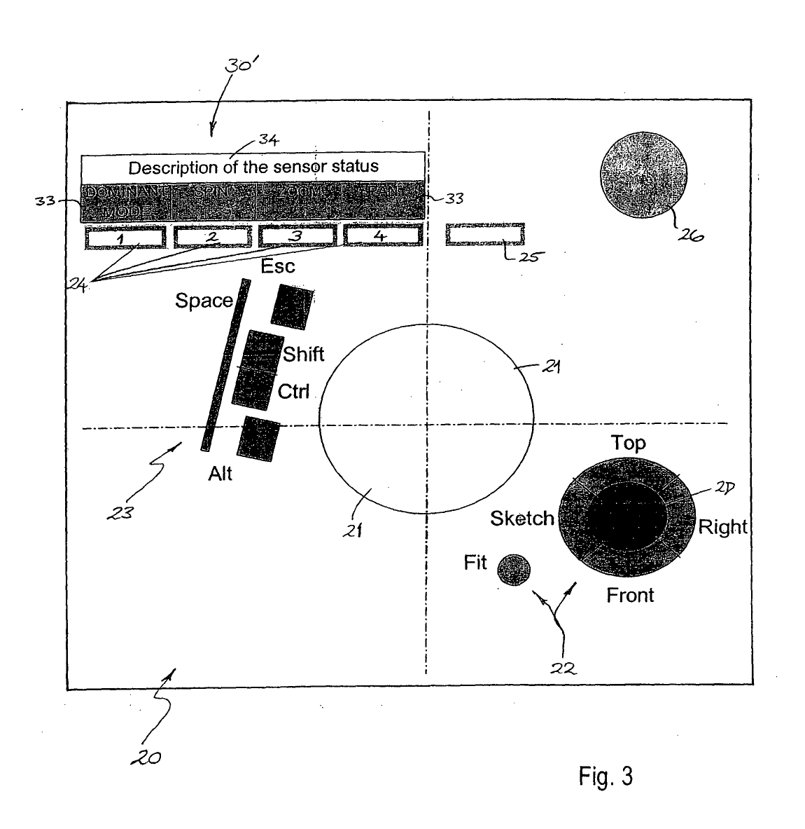

Referring now to FIG. 3 of the drawings, details of the layout for a control panel 20 according to a slightly different embodiment of a user interface device 100 according to invention is illustrated. The first group of buttons 22 is unchanged, and the second group of buttons 23 is also substantially the same—although this time also including a fifth “space bar” button. In this instance, however, the control panel 20 itself incorporates a display means 30′ in the form of four discrete windows or screens 33, each of which is associated with a separate one of the four programmable buttons numbered 1 to 4 in the button group 24. As can be seen, the group of programmable buttons 24 is in this instance arranged together at the top left-hand side of the control panel 20. Each of the windows or screens 33 may be an LCD, or may more simply be adapted for illumination to indicate the programmed function that is selected upon pressing the corresponding one of the buttons 24. In one embodiment, each of these buttons 24 may be programmed to change the operation of the knob-like manipulation member 21. The display means 30′ may furthermore comprise a field 34 where longer messages or instructions can be displayed.

A fifth button 25, in line with the group 24, may be a power on-off switch for turning the user interface device 100 on and off. Alternatively, it may be used to re-start or re-set the programming for the group of buttons 24. A further button 26, which is provided at the top right-hand side of the schematic layout for the control panel 20 shown in FIG. 2, is a sensitivity controller—typically in the form of a continuous potentiometer. This sensitivity button 26 enables the user to adjust and set the sensitivity in every application for which the device 100 is used.

The user interface device 100 of the present invention provides a compact and very user-friendly device for freely navigating the point of view of a digital image or model, and enabling both zoom and pan operations to be performed simultaneously. Thus, the device 100 of the invention can provide the user with a very natural and intuitive way to explore and manipulate two-dimensional and three-dimensional images and designs in the computer environment, particularly within a CAD/CAM or image processing software application. Another advantage of the invention is that it reduces the necessity for the user to make frequent hand motions to and from and operating keyboard—especially when the user interface device 100 incorporates the group of “keyboard” or “high frequency” buttons 23.

The user interface device 100 of the invention is typically envisaged for operation in conjunction with a regular computer monitor and keyboard and a conventional computer mouse. As described above, the user interface device 100 of the invention is preferably designed for left-handed use, in which case the user will typically operate the conventional mouse with the right hand. The conventional mouse and keyboard remain integral elements of the overall design process, with the mouse typically being used in 2D drafting mode, e.g. in a “sketching phase” for sketching geometries, and for selecting and confirming commands. The keyboard meanwhile is typically used to input numbers (such as dimensions) and text (such as file names).

The user interface device 100 of the invention is especially suited to motion control input with 3D models, objects and designs; for example, in a “finishing phase” during which design details such as holes, rounds, chamfers, threads, etc. are added, and in the “editing, assembling and understanding phases” during which the dimensions of the components may be controlled and modified, and the completed components assembled together. Nevertheless, as described above, the device 100 according to the invention may also be adapted for operation in the 2D mode (e.g. actuation of the 2D button 22) thereby reducing the user's reliance on the conventional mouse.

As can be seen from FIG. 4, the profile of the ergonomic input device 100 according to the present invention can present a particular wedge shape. Generally the upper surface 200 of the base part 10 is gradually rising from the region 201 of the palm rest to the region 202 of the base of the manipulation member and then to the region 203 of the display. The gradient of the upper contour of the base thereby is preferably the steepest in the are of the display which ergonomically assists the inclined orientation (angle “alpha”) of the display 30.

Alternatively, the upper contour 200 of the base part 10 can be essentially flat at the end of the palm rest and only rise to a higher level at the side of the display

Due to the inclination of the display 30 the view of the user will impinge on the display 30 in a more vertical angle thus enhancing the contrast of the display and reducing reflections.

Generally, the thickness of the base part 10 can be higher at the region 203 of the display 30 than at the other end 201.

To further improve the ergonomics of the input device 100, the center axis of the manipulation member 21 can be inclined in angle “beta” to the vertical on the support surface 300.

As can be seen from FIG. 4, the underside 204 of at least one end region of the base 10, preferably the underside 204 of the region of the display 30 can be raised vis-a-vis the support 300.

1-10. (canceled)

11. An ergonomic device (100) for manual input of control signals in a computer-controlled environment,
the device (100) comprising:
a base (10) geometrically arranged to rest on a support surface (300);
a manipulation member (21) mounted on the base for manual manipulation by a user, the manipulation member being movable relative to the base (10) for generating corresponding input control signals within the computer environment;
a display (30) provided on the base (10); and
a palm rest (40) provided on the base for supporting the palm of the user's hand during use of the device (100),
wherein at least the underside (204) of one end of the base (10), preferably the underside of the region of the display (30), is elevated from the support.

12. An ergonomic device (100) for manual input of control signals in a computer-controlled environment,
the device (100) comprising:
a base (10) geometrically arranged to rest on a support surface (300);
a manipulation member (21) mounted on the base for manual manipulation by a user, the manipulation member being movable relative to the base (10) for generating corresponding input control signals within the computer environment;
a display (30) provided on the base (10); and
a palm rest (40) provided on the base for supporting the palm of the user's hand during use of the device (100),
wherein the manipulation member (21) is arranged between the display (30) and the palm rest (40) and wherein the display (30) is inclined in an acute angle to the support surface (300).

13. The device according to claim 1, wherein the palm rest (40) is exchangeable.

14. The device according to claim 1, wherein the upper surface of the base (10) is higher in the region of the display (30) than in the region of base of the manipulation member (21).

15. The device according to claim 1, wherein the center axis of the manipulation member (21) is inclined relative to the vertical on the support surface.

16. The device according to claim 1, wherein the device (100) is configured such that, when the palm of the user's hand is located on the palm rest (40), the manipulation member (21) is located in general alignment with and within reach of the middle three fingers of the hand, and a first group of buttons (22, 23, 24) is arranged in one of the following positions:
(i) in the vicinity of the user's thumb, or
(ii) in the vicinity of the user's smallest finger.

17. The device according to claim 1, wherein the device (100) includes at least two groups of user input buttons (22, 24), one of said groups (24) comprising buttons whose function is able to be programmed, and the other group (22) comprising buttons having a pre-set or predetermined operation, one of said groups (22) being arranged in the vicinity of the user's thumb and the other said group (24) being arranged in the vicinity of the user's smallest finger.

18. The device according to claim 1, wherein at least the underside (204) of one end of the base (10), preferably the underside of the region of the display (30), is elevated from the support.

19. The device according to claim 2, wherein the palm rest (40) is exchangeable.

20. The device according to claim 2, wherein the upper surface of the base (10) is higher in the region of the display (30) than in the region of base of the manipulation member (21).

21. The device according to claim 2, wherein the center axis of the manipulation member (21) is inclined relative to the vertical on the support surface.

22. The device according to claim 2, wherein the device (100) is configured such that, when the palm of the user's hand is located on the palm rest (40), the manipulation member (21) is located in general alignment with and within reach of the middle three fingers of the hand, and a first group of buttons (22, 23, 24) is arranged in one of the following positions:
(i) in the vicinity of the user's thumb, or
(ii) in the vicinity of the user's smallest finger.

23. The device according to claim 2, wherein the device (100) includes at least two groups of user input buttons (22, 24), one of said groups (24) comprising buttons whose function is able to be programmed, and the other group (22) comprising buttons having a pre-set or predetermined operation, one of said groups (22) being arranged in the vicinity of the user's thumb and the other said group (24) being arranged in the vicinity of the user's smallest finger.

24. The device according to claim 2, wherein at least the underside (204) of one end of the base (10), preferably the underside of the region of the display (30), is elevated from the support.

25. An ergonomic device (100) for manual input of control signals in a computer-controlled environment, the device (100) comprising:
a base (10) geometrically arranged to rest on a support surface (300);
a manipulation member (21) mounted on the base for manual manipulation by a user, the manipulation member being movable relative to the base (10) for generating corresponding input control signals within the computer environment;
a display (30) provided on the base (10),
wherein the display (30) is inclined in an acute angle to the support surface (300), the inclination of the display being steeper than the inclination of the top surface of the base (10) outside the display (30).

26. An ergonomic device for manual input of control signals in a computer-controlled environment,
the device (100) comprising:
a base (10) geometrically arranged to rest on a support surface (300);
a manipulation member (21) mounted on the base for manual manipulation by a user, the manipulation member being movable relative to the base (10) for generating corresponding input control signals within the computer environment;
a display (30) provided on the base (10),
wherein the upper surface of the base (10) is higher in the region of the display (30) than in the region of base of the manipulation member (21).
